(19) United States
(12) Patent Application Publication
(10) Pub. No.: US 2025/0203467 A1
(43) Pub. Date: Jun. 19, 2025

(54) MEASUREMENTS IN A COMMUNICATION SYSTEM

(71) Applicant: NOKIA TECHNOLOGIES OY, Espoo (FI)

(72) Inventors: Alperen Gundogan, Munich (DE); Ahmad Awada, Munich (DE); Subramanya Chandrashekar, Bangalore (IN); Umur Karabulut, Munich (DE); Panagiotis Spapis, Munich (DE); Srinivasan Selvaganapathy, Bangalore (IN); Amaanat Ali, Espoo (FI)

(21) Appl. No.: 18/833,703

(22) PCT Filed: Feb. 4, 2022
(86) PCT No.: PCT/EP2022/052679

§ 371 Date: Jul. 26, 2024

(51) Int. Cl. H04W 36/00; H04W 36/08

(52) U.S. Cl. CPC H04W 36/0058; H04W 36/0088; H04W 36/085

(57) ABSTRACT

Apparatus and methods for processing information of Layer 1 measurements taken by a communication device are disclosed. In the processing information of timing of Layer 1 measurements is used to adapt the Layer 1 measurements with Layer 2 filtering.

### FIELD

The present disclosure relates to methods, apparatus and computer program products for processing measurement information in a communication system, especially processing measurement information for handover decisions.

### BACKGROUND

Communications can be provided, for example, by means of a communication network and one or more compatible communication devices. In a mobile or wireless communication system at least a part of communication between at least two devices occurs over a wireless or radio link. Examples of wireless systems comprise public land mobile networks (PLMN), satellite-based communication systems and different wireless local networks, for example wireless local area networks (WLAN).

A communication device or terminal is often referred to as user equipment (UE). A communication device is provided with an appropriate signal receiving and transmitting apparatus for enabling communications, for example enabling access to a communication network or communications directly with other users. A communication device of a user may receive signalling from a radio access network (RAN), for example an access point of a RAN, and transmit and/or receive communications accordingly. An access point can provide one of more cells. Communication may comprise, for example, communication of data for carrying communications such as voice, video, electronic mail (email), text message, multimedia and/or content data and so on. Non-limiting examples of services provided comprise two-way or multi-way calls, data communication, multimedia services and access to a data network system, such as the Internet. It is also possible to multicast/broadcast data to communication devices.

Mobility can be provided for wireless communication devices such that a mobile device may move, i.e., be handed over, from an access point to another. A handover decision is made based on measurements, the aim being that the communication device is communicating via an optimal access point. Measurements of signal power of serving cell and neighbour cells are made periodically to assess the quality of each cell to be used in handover decisions. The measurements are processed, for example filtered, to achieve optimised handover decisions.

The communication system and associated devices typically operate in accordance with a given standard or specification which sets out what the various entities associated with the system are permitted to do and how that should be achieved. Communication protocols and/or parameters which shall be used for the connection are also typically defined. Different actions can be handled on different layers of a protocol stack. One example of a communications system is UTRAN (3G radio). Other examples of communication systems are the long-term evolution (LTE) of the Universal Mobile Telecommunications System (UMTS) radio-access technology and so-called fifth generation (5G) or New Radio (NR) networks. 5G is standardized by the 3rd Generation Partnership Project (3GPP).

### SUMMARY

In accordance with an aspect there is provided a method for processing information of Layer 1 measurements taken by a communication device, the method comprising using information of timing of the Layer 1 measurements to adapt the Layer 1 measurements with Layer 2 filtering.

According to a more specific aspect the information of the timing of Layer 1 measurements is included in a measurement report by the communication device. This may comprise including an indication of measurement age of a measurement sample in the measurement report.

The communication device, a handover source entity and/or a handover target entity may be configured to handle reporting of the information of the timing of Layer 1 measurements. The handling may comprise operations such as including and sending by the communication device and receiving and using by a network entity.

Information of timing of Layer 1 measurements may comprise information of a time difference between the timing of reporting of a measurement sample and the timing of obtaining the measurement sample. Information of timing of Layer 1 measurements may also comprise a flag indicative whether a measurement of a corresponding reference signal is taken after a previous measurement report.

Pre-processing of the Layer 1 measurements may be performed by the communication device in accordance with Layer 2 filter configuration. The communication device can report the pre-processed measurement information for use in the Layer 2 filtering. The communication device may receive Layer 2 filter configuration information for the pre-processing. A handover source entity may provide at least a part of the Layer 2 filter configuration information for use in the pre-processing. At least a part of Layer 2 filter configuration information may be provided via a handover target entity.

A central node controlling at least one of a handover source entity and a handover target entity may determine the pre-processing method to be used and provide information of the determined pre-processing method on a higher layer signaling to the communication device.

A handover source entity may determine the pre-processing method to be used and provides information of the determined pre-processing method.

The communication device may compute a filtering coefficient to be used in the Layer 2 filtering.

The communication device may determine a new measurement reporting interval.

A Layer 2 filter may be adapted based on the information of timing of Layer 1 measurements.

Input into a Layer 2 filter may be adapted based on the characteristics of the Layer 2 filter.

The adapting may comprise at least one of adjusting a filtering coefficient, adjusting a forgetting factor, weighting the Layer 1 measurements, adjusting timing of processing the measurement results, comparing the timing information to a timing threshold, adaptation of Layer 2 filter time characteristics and/or applying the sampling rate to Layer 2 Infinite Impulse Response filtering such that the time characteristics of the Layer 2 filter are preserved.

In accordance with another aspect there is provided an apparatus comprising at least one processor and at least one memory including a computer program code, the at least one memory and computer program code configured to, with the at least one processor, cause the apparatus at least to process information of Layer 1 measurements taken by a communication device, the processing comprising use of information of timing of the Layer 1 measurements to adapt the Layer 1 measurements with Layer 2 filtering.

The apparatus may comprise a communication device configured to include into a measurement report an indication of measurement age of a measurement sample.

The apparatus may comprise a network device configured to obtain from a measurement report an indication of measurement age of a measurement sample.

The apparatus may comprise and be configured to handle a report of the information of the timing of Layer 1 measurements in at least one of the communication device, a handover source entity and/or a handover target entity.

Information of the timing of Layer 1 measurements may comprise information of a time difference between the timing of reporting of a measurement sample and the timing of obtaining the measurement sample. The information of the timing of Layer 1 measurements may also comprise a flag indicative whether a measurement of a corresponding reference signal is taken after a previous measurement report.

The communication device may be configured to perform the Layer 1 measurements and include information of the timing of the performed Layer 1 measurements in a measurement report and send the report to a network entity.

The communication device may be configured to pre-process Layer 1 measurements in accordance with Layer 2 filter configuration and report the pre-processed measurement information for use in the Layer 2 filtering. The communication device may be configured to receive and apply Layer 2 filter configuration information for the pre-processing. A handover source entity and/or a handover target entity may be configured to provide at least a part of Layer 2 filter configuration information for use in the pre-processing.

A pre-processing method to be used many be determined by a central node controlling at least one of a handover source entity and a handover target entity. Information of the determined pre-processing method may be provided on a higher layer signaling to the communication device. A pre-processing method to be used may also be determined and provided by a handover source entity.

The communication device may be configured to compute a filtering coefficient to be used in the Layer 2 filtering.

The communication device may be configured to determine a new measurement reporting interval.

The apparatus may be configured to adapt a Layer 2 filter based on information of timing of Layer 1 measurements.

The apparatus may be configured to adapt the input into a Layer 2 filter based on the characteristics of the Layer 2 filter.

The apparatus may be configured to adapt at least one of a filtering coefficient, a forgetting factor, weighting of Layer 1 measurements, timing of processing of measurement results, and Layer 2 filter time characteristics.

The apparatus may be configured to compare the timing information to a timing threshold.

The apparatus may be configured to apply the sampling rate to Layer 2 Infinite Impulse Response filtering such that the time characteristics of the Layer 2 filter are preserved.

The communication device may comprise a multi-panel device configured to perform measurements in at least two directions.

Means for implementing the herein disclosed operations and functions can also be provided. The means can comprise appropriately configured hardware and software.

A computer software product embodying at least a part of the herein described functions may also be provided. In accordance with an aspect a computer program comprises instructions for performing at least one of the methods described herein.

### BRIEF DESCRIPTION OF DRAWINGS

Some aspects will now be described in further detail, by way of example only, with reference to the following examples and accompanying drawings, in which:

FIG. 1 illustrates a schematic example of a system where the invention can be practiced;

FIG. 2 shows an example of a control apparatus;

FIG. 3 shows an example of a multi-panel communication device;

FIG. 4 shows examples possible operation mode of a multi-panel communication device;

FIG. 5 shows an exemplary signaling diagram for L1/2 inter-cell mobility;

FIGS. 6 and 7 are flowcharts according to certain examples;

FIGS. 8 and 9 are signaling flowcharts according to certain examples of network based L1/L2 filter adaptation;

FIGS. 10A, 10B, 10C and 10D show results of simulations of a network based L1/L2 filter adaptation method with different measurement ages; and

FIGS. 11 and 12 are signaling flowcharts according to certain examples of communication device based L1/L2 filter adaptation.

### DETAILED DESCRIPTION OF EXAMPLES

The following description gives an exemplifying description of some possibilities to practise the invention. Although the specification may refer to “an”, “one”, or “some” examples or embodiment(s) in several locations of the text, this does not necessarily mean that each reference is made to the same example of embodiment(s), or that a particular feature only applies to a single example or embodiment. Single features of different examples and embodiments may also be combined to provide other embodiments.

Wireless communication systems provide wireless, or radio, communications to devices connected through access points such as base stations. In the following, different scenarios will be described using, as an example of an access architecture, a 3GPP 5G radio architecture. However, embodiments are not necessarily limited to such an architecture and similar principles can be applied to other systems and generations of the 3GPP standard.

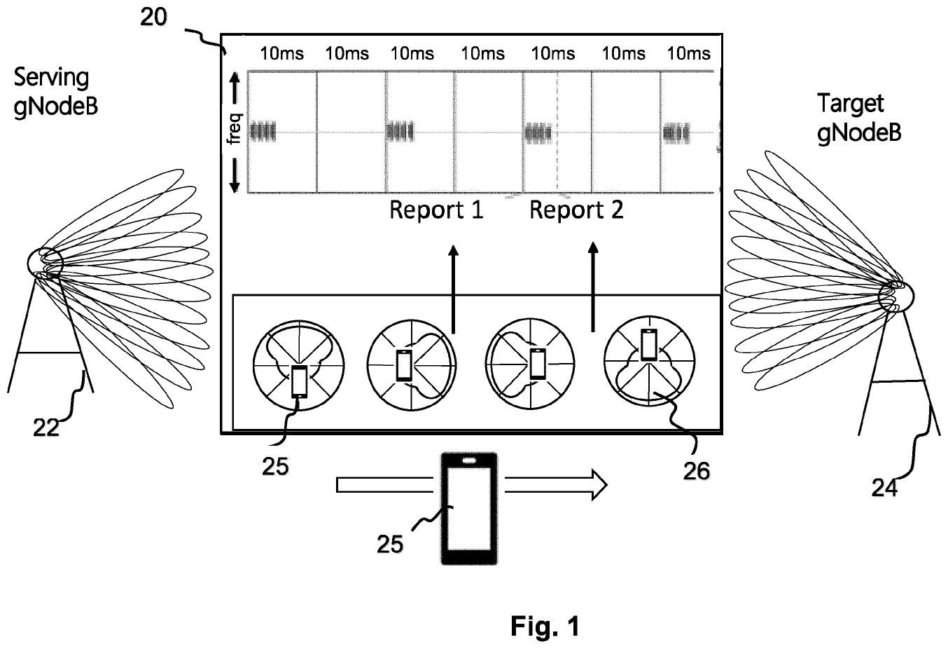

FIG. 1 shows a schematic example of a communication system comprising a radio access system. A radio access system can comprise one or a plurality of access points/base stations. An access point/base station may provide one or more cells. An access point can comprise any node that can transmit/receive radio signals (e.g., a TRP, a 3GPP 5G base station such as gNB (gNodeB), eNB, a user device and so forth). It is noted that for simplicity FIG. 1 shows only two access points 22 and 24. A node for controlling the access points can also be provided.

A communication device 25 can be located in the area of cells of one or more radio access points/stations 22 and 24 and can listen to both of them. As indicated by the arrow the communication device 25 may move within the area and thus may need to be handed over from a cell to another. Mobility functions to achieve this will be explained in more detail below.

For example, in 3GPP 5G a gNB can be divided between two physical entities: central unit (CU) and distributed unit (DU). A CU provides support for the higher layers of the protocol stack such as Service Data Adaptation Protocol (SDAP), Packet Data Convergence Protocol (PDCP) and Radio Resource Control (RRC) while DU provides support for the lower layers of the protocol stack such as Radio Link Control (RLC), Medium Access Control (MAC) and the physical layer. A single CU can be provided for each gNB. One CU in turn may control multiple DUs. Each DU may be able to support one or more cells.

A handover can take place between a serving gNB and a target gNB. Each gNB may be divided into serving DU and target DU and serving cell and target cell, and the handover may also take place within a gNB between the DUs thereof as an inter-DU handover. Hanover may also be between DUs of different gNBs. Signalling flowcharts in this specification show examples of signalling in relation to DU1 and DU2 but it is noted that similar principles apply also to other HO scenarios. In this specification the terms source entity and target entity are used to cover any possible party of the handover.

The communication device 25 may comprise any suitable device adapted for wireless communications. A communication device is often referred to as a user equipment (UE). Non-limiting examples comprise a mobile station (MS) (e.g., a mobile device such as a mobile phone or what is known as a ‘smart phone’), a computer provided with a wireless interface card or other wireless interface facility (e.g., USB dongle), personal data assistant (PDA) or a tablet provided with wireless communication capabilities, machine-type communications (MTC) devices, Internet of Things (IoT) type communications devices, a Cellular Internet of things (CIoT) device or any combinations of these or the like. The communication device may be provided as part of another device. The device may receive signals over an air or radio interface via appropriate apparatus for receiving and may transmit signals via appropriate apparatus for transmitting radio signals. The communications can occur via multiple paths. To enable multiple input multiple output (MIMO) type communications devices can be provided with multiantenna elements. An example of such will be explained below with reference to FIG. 3.

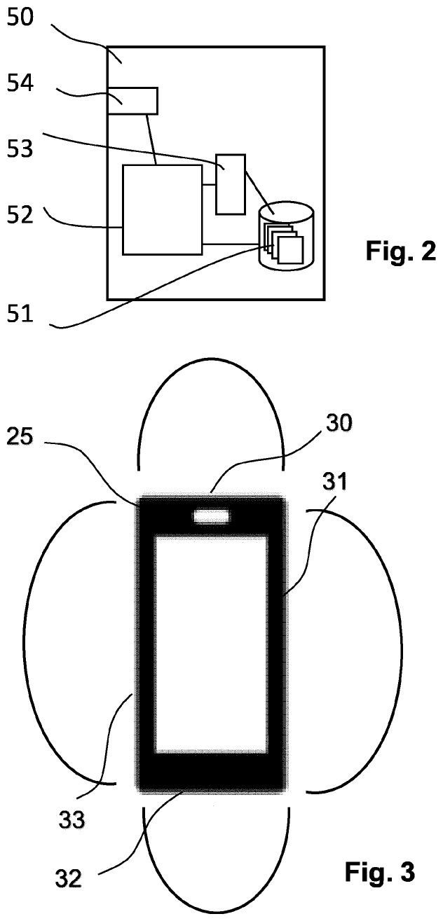

Access points and communications devices are provided with data processing apparatus comprising at least one processor and at least one memory. FIG. 2 shows an example of a data processing apparatus 50 comprising processor(s) 52, 53 and memory or memories 51. FIG. 2 further shows connections between the elements of the apparatus and an interface for connecting the data processing apparatus to other components of the device. The at least one memory may comprise at least one ROM and/or at least one RAM. The apparatus may comprise other possible components for use in software and hardware aided execution of tasks it is designed to perform, including implementing the herein described features in relation to mobility measurements and processing. The at least one processor can be coupled to the at least one memory. The at least one processor may be configured to execute an appropriate software code to implement one or more of the following aspects. The software code may be stored in the at least one memory, for example in the at least one ROM.

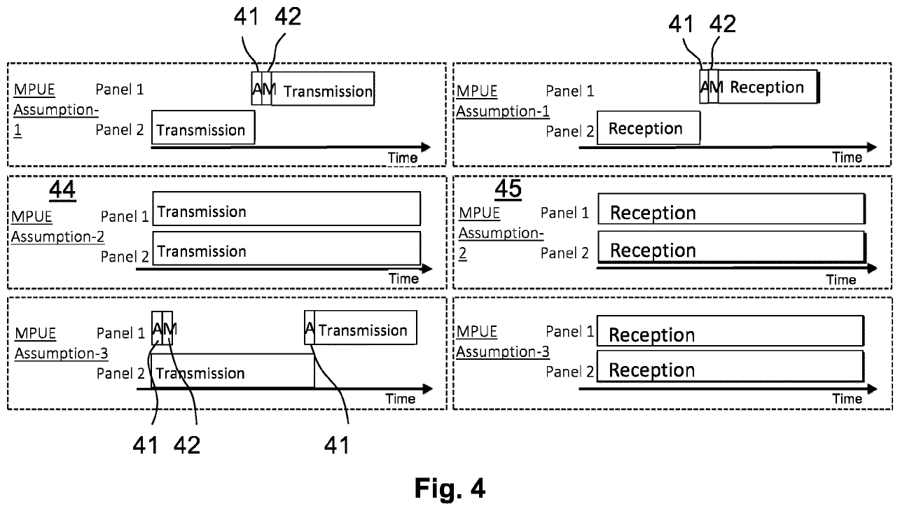

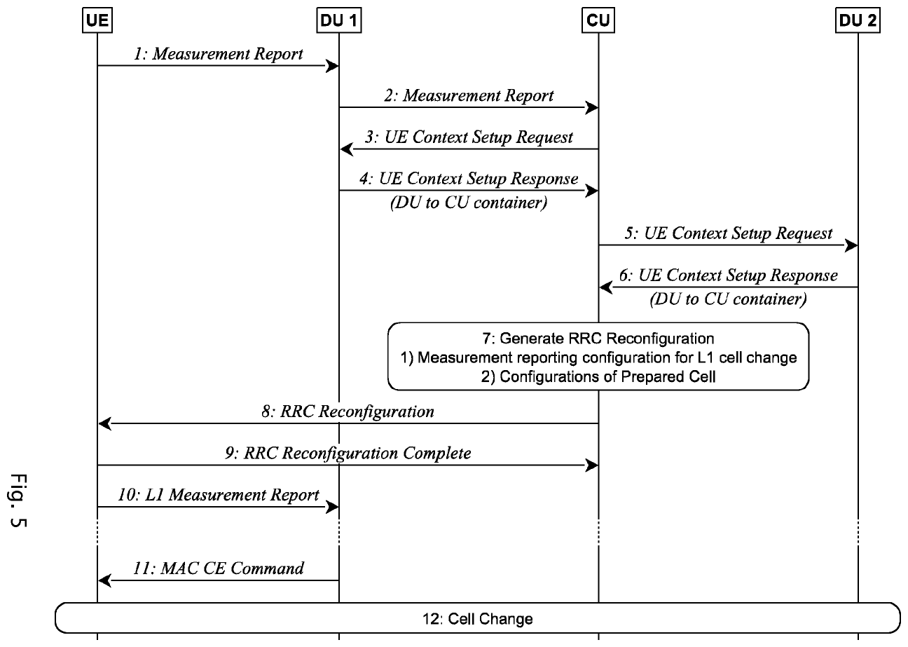

A Multi-Panel User Equipment (MPUE) refers to a concept where a UE may simultaneously transmit and receive using its multiple antenna panels, depending on the UE hardware architecture. A schematic example of a multi-panel UE is shown in FIG. 3 illustrating beams 30, 31, 32 and 33 by four panels of the device 25. The UE hardware architecture implementations may result in different UE capabilities and power consumption levels. Various MPUE types have been proposed, FIG. 4 showing some example implementations.

Depending on the UE hardware architecture, a MPUE can activate all panels simultaneously for simultaneous measurements of serving cell and neighbour cell powers. Each panel can be activated independently with different activation frequency. The activation periodicity of each panel determines the sampling rate of each panel, i.e., how often a panel does sampling of cell measurements over time. Sampling rate of each panel and panel activation periodicity can be decided by the UE. The sampling rate is typically implementation specific. In the case of a MPUE, panel sampling rate can have a significant impact on mobility performance since the rate at least in part determines the accuracy of the measurements where UEs measure the signal power of serving cell and neighbor cells periodically to assess the quality of each cell to be used in handover decisions.

Multiple panels can be implemented on a UE such that only one panel is activated at a time for uplink (UL) and downlink (DL), see FIG. 4 top row. In this case the UE has multiple antenna panels but only a single baseband processing chain to measure Synchronization Signal Blocks (SSBs) on each of them. The UE follows a panel switching schedule, i.e., the UE switches the baseband to radio frequency (BB-to-RF) panel connection one SSB burst at the time. The activation of and switching to a panel introduces a “switching delay” of few ms (e.g., 3 ms). The MPUE may have several radio frequency (RF) antenna modules connected to a single baseband architecture. This can mean that the RF module is switched on early to allow for a quasi instantaneous switch of a panel. Therefore, the duration of activation (A; time blocks 41 in FIG. 4) and measurement (M; time blocks 42 in FIG. 4) may vary based on MPUE RF module design. This implementation may have only a single transceiver and mmWave baseband digital unit with only a single Tx chain and two Rx chains (one per polarization).

The middle row of FIG. 4 shows a possibility where multiple panels can be activated at a time and one or more panels can be used for transmission (FIG. 2, the left block 44 in the middle row) and reception (FIG. 2, the right block 45 in the middle row).

FIG. 4 bottom row shows scenario where multiple panels can be activated at a time for reception and measurements, since each of them has its own baseband processing chain. However, only one panel can be used for transmission.

FIG. 1 shows a scenario where the communication device 25 moves in the direction from base station 22 to base station 24. It may therefore become necessary to determine if the communication device shall be handed over from the current serving base station 22 (source) to the new base station 24 (target). The lower part of the block in the middle of FIG. 1 illustrates how the different panels of the device 25 are directed to four different directions in different time instances. The effect of the differently directed beams 26 to the measurements and reporting at different time instances is also illustrated. As is evident, a different measurement result can be reported in Reports 1 and 2. It is also possible that the device is rotated relative to the base stations which can cause further complication in the processing of the mobility features.

The differing measurement conditions may affect Layer 1/Layer 2 (L1/2) inter-cell mobility processing. This can be well demonstrated with examples related to the multi-panel user equipment (MPUE), the measurement model at the MPUE and Channel State Information (CSI) measurement reporting. Therefore a brief overview of the issues in relation to these is given first.

5G New Radio and, in particular, Multi-RAT Mobility (MRM) concept enables and improves mobility/cell-changes in Radio Access Network (RAN) deploying the Central-Unit (CU)-Distributed-Unit (DU) structure. This enables operations between different DU (inter-DU) of different operators via a CU (involving the Control Plane and/or User Plane aspects of the Central-Unit, CU-CP, CU-UP). L1/2 inter-cell mobility is performed by the MAC layer terminated in the Distributed Unit (DU) and not in Layer 3 (L3) based on the Radio Resource Control (RRC).

FIG. 5 shows an exemplary implementation for the signalling diagram of L1/2 inter-cell mobility from a serving cell in DU1 to a target cell in DU2 (inter-DU intra-CU scenario). The same diagram would apply as well in case of intra-DU intra-CU cell change where DU1 would be the same as DU2. The main steps of L1/2 inter-cell mobility can be summarized as following. In step 1, a UE sends measurement report containing its cell quality measurements of serving and neighbouring cells. The UE can be configured by the serving cell to send measurement report early when it still has a good connection to the serving cell. Using the reported cell quality measurements (in step 2), the CU can identify a potential set of candidate target cell to which the UE can be handed over to. In this example, the CU identifies candidate target cells that are served by DU1 (controlling the serving DU/cell as well) and another DU2 that is controlled by the same CU. In step 3, the CU requests the preparation of a candidate target cell in DU1 by sending UE Context Setup Request message to create an UE context and setup one or more data bearers. This message includes a HandoverPreparationInformation Information Element (IE). In step 4, DU1 provides the configuration of the UE in UE Context Setup Response message containing a container from DU to CU. The same steps 4/5 are performed with respect to DU2 to prepare target cell(s) that are controlled by DU2. Having received the UE configurations in the candidate target cell, the CU generates an RRC Reconfiguration that is sent to the UE in step 8. The RRC Reconfiguration message contains a measurement reporting configuration for L1/2 handover, i.e., configuration on how to report the L1 beam measurements of serving and target cells in step 10. The message can also contain configuration of the prepared candidate cell which the UE needs to execute when it receives a MAC CE command to change the serving cell (perform handover) as shown in step 11. After confirming the RRC Reconfiguration to the network in step 9, the UE starts to report periodically the L1 beam measurements of serving and candidate target cells as shown in step 10. Upon determining that there is a target candidate cell having a better radio link beam measurement than the serving cell the serving cell sends a MAC Control Element (MAC CE) or a L1 message to trigger the cell change to the target candidate cell. The determining may be based, e.g., on detection that L1-RSRP of target beam measurement is greater than L1-RSRP of serving beam measurement plus Offset for e.g., Time-to-Trigger (TTT) time. The handover from the serving cell to the target cell can then be executed by the UE in step 12. L1 inter-cell mobility provides advantage compared to baseline handover and conditional handover in that the interruption during the handover execution can be reduced. A reason for this is that the UE does not need to perform higher layer (RRC, PDCP) reconfiguration.

Mobility Measurements are briefly explained next. An example of a beam measurement model for a UE is described in 3GPP TS 38.300 release 18. The beams can refer to SSB or CSI-RS resources. The UE may apply Layer 1 averaging to the set of beams to reduce the fluctuations in measurements caused by fast fading and measurement error. The accuracy of the Layer 1 measurements can be left for UE implementation. However, a certain minimum accuracy is typically guaranteed by the means of performance requirements. In principle, the UE can select any L1 sampling rate, filter realization, or L3 output rate as long as the minimum requirements are satisfied. At next step, the average of N strongest beams above the threshold are fed into the Infinite Impulse Response (IIR) Layer 3 filtering. 3GPP TS 38.331, section 5.5.3.2 defines the Layer 3 filtering procedure as Fₙ=(1−α)*Fₙ₋₁+α*Mₙ where Mₙ is the latest received cell quality measurement, and Fₙ is the updated measurement result used for evaluation of reporting criteria and report at the next step. A forgetting factor is used, defined as

$$α = {2}^{\frac{- {k}_{L 3}}{4}} ,$$

where k_{L3} is the layer 3 filterCoefficient for the corresponding measurement quantity, e.g., Reference Signals Received Power (RSRP), or Reference Signals Received Quality (RSRQ) and defined in the MeasObjectNR which can be sent to the UE along with RRC reconfiguration message or the RRC resume message. The Layer 3 filterCoefficient can take a value between 0 and 19 (0 means disable L3 filtering). Filtering reporting period equals one measurement period. Reporting period equals one measurement period. The alpha α value is adapted such that the time characteristics of the filter are preserved at different input rates, observing that the filterCoefficient assumes a sample rate equal to X ms. The value of X is equivalent to one intra-frequency L1 measurement period as defined in 3GPP TS 38.133 (assumes non-DRX operation and depends on frequency range). The network signals filterCoefficient k_{L3} to the MPUE using an RRC Reconfiguration message, X being specified in 3GPP specifications. Based on k_{L3} and X ms values, the UE derives initial a value for layer 3 (L3) filtering calculations and the filtering time constant T_{cst} (assuming that sampling rate equal to X ms) which is computed as

$${T}_{cst} = \frac{- X \cdot ln ( 2 )}{ln ( 1 - α )} = \frac{- X}{{log}_{2} ( 1 - α )}$$

The delay between the L1 measurements and L3 filtering can be estimated by the filter time constant which is defined as the time duration after which (1−α) reduces to half

$$( ( 1 - α ) is a constant value taking α = {2}^{\frac{- {k}_{L 3}}{4}} ) .$$

Simply, (1−α) reduces to adjusts the impact of previous measurements, i.e., Fₙ₋₁ on the new measurement, i.e., Mₙ. As stated, L1 of the UE can be limited to measure at various sampling rate, i.e., Tₛₘₚ depending on number of panels, the switching schedule and the switch delay as explained in section 2. For MPUEs a new α′ is calculated such that the filter time constant T_{cst} of the filter is preserved:

$$( 1 - α ) = {( 1 - {α}^{′} )}^{\frac{X}{{T}_{smp}}}$$

The UE derives a new forgetting factor α′ for its sampling rate Tₛₘₚ based on the configured filter coefficient k_{L3} (leading to forgetting factor α) corresponding to a specified sample rate X.

It is noted that the measurement model for L3 mobility is explained here to illustrate the details of L3 mobility measurement procedure. For L1/2 inter-cell mobility, the UE reports L1 filtered beam measurements, e.g., L1-RSRP of both serving and target cells. Hence, the measurements can be transmitted from the UE to the network for L1/2 mobility decisions. So, there are no cell quality measurements (L3 filtered) reported as a part of L1 beam measurement reporting. Differences between in L3 mobility and L1/2 intercell mobility can have an impact on handover procedures, e.g., in view of handover deactivation delay and interruption time. For L3 mobility, if the Layer 3 cell quality measurement of the non-serving cell (target cell) is higher than the serving cell quality measurement by the HO margin during TTT, the UE sends Layer 3 measurement report to the serving cell. Once the serving cell receives the L3 measurement report from the UE, it initiates the preparation of the HO command through RRC reconfiguration. L1/L2 based mobility differs from the L3 mobility in the sense that the serving cell change (handover) is triggered using L1-RSRP beam measurements instead of L3 cell quality measurements. The UE sends periodical L1-RSRP beam measurement reports to the serving cell including the K strongest beams of the non-serving cell(s). HO is triggered if the L1-RSRP measurement of the best non-serving cell beam is higher than the best serving cell beam by the HO margin, e.g., 3 dB. For L1/L2-centric inter-cell mobility the RRC configurations of the non-serving cell can be assumed to be already pre-configured at the UE (similar to CHO). Therefore, HO preparation delay for L1/L2 signalling can be assumed to be 0 ms and there is no TTT timer which leads to shorter a HO deactivation delay for L1/L2-centric inter-cell mobility.

This was simulated based on settings where the interruption time for L1/L2 (RACH-less) was set to 1 ms assuming that UE has decoded all the RRC configurations of the non-serving cell (i.e., possible target cell/new serving cell) beforehand and UE does not need RACH as timing advance (TA) is zero or the same as the serving cell i.e. RACH-less. For other HO procedures, the interruption time was assumed to be 80 ms. The number of handovers per UE and the ping-pong handovers per UE per second was then assessed. A ping-pong handover happens, for example, if cell A hands over a UE to cell B and cell B hands over the same UE back to cell A shorty after. The duration was set to 1000 ms in the simulations. The shorter HO deactivation delay (lack of TTT, L3 IIR filtering) for L1/L2 mobility resulted in higher number of handovers and ping-pongs compared to L3 mobility. No ping-pong handover was observed in L3 with long delay. The handovers can be triggered for L1/L2 mobility if L1-RSRP measurements of the non-serving cell beam is higher than the serving cell beams by HO margin whereas for L3 mobility the UE applies L3 filtering and waits for so called A3 event to be met for TTT before sending the measurement report. Overall, the simulations showed that the number of handovers and ping-pongs increases with L1/L2 centric mobility compared to L3 mobility. The higher number of ping-pongs can increase the network overhead (especially for inter-DU intra-CU scenario) which can lead high interruption time for UE, assuming that the UE performs Random Access Channel (RACH) procedure on every cell change. Ping-pongs between cells of different DUs can be costlier than beam switching in the serving cell. This is so because of higher interruption time (due to RACH) and network signalling.

The impact of the ping-pongs can be reduced by applying additional Infinite Impulse Response (IIR) filtering, i.e., L2 filter on received L1-RSRP measurements at the network to reduce the fluctuations of the L1 beam measurements. This layer 2 filtering at the network improves the measurement accuracy and can reduce the number of ping-pongs in the system. Applying a proper L2 filter at the network is not feasible with the current CSI measurement reporting. This can be especially the case for the first of the MPUE implementations explained with reference to FIG. 4 where only one panel can be activated at a time. A reason for this is a mismatch between the time of the L1 filtered measurement at the UE and the time of L1 measurement available at the network for L2 filtering.

The following considers this in the context of the scenario presented in FIG. 1 and assuming that the SSB periodicity is 20 ms and reporting periodicity is also 20 ms with a four panel UE where one panel can be activated at a time. The strongest beam of the target cell is measurement in SSB2 at time t+20 ms from the right panel of the UE. A new L1 filtered measurement is calculated. The network configures UE to send the best K strongest non-serving cell measurements, meaning that the SSB2 measurement is included in Report 1. At the time t+40 ms, the UE activates left panel and receives measures SSB3 of the target gNB. The measurement of the SSB3 is lower than SSB2 measurement at time t+20 ms as the left panel beams are not able to see the target gNB beams since backwards attenuation of the antenna element power radiation pattern is typically around 25 dB. This can be due to various reasons, e.g., blockage and non-line of sight (NLOS) scattering. The measurement of SSB3 may thus vary. The UE will report the best K non-serving cell measurement in Report 2 and will include the SSB2 measurement as it is stronger than the SSB3 measurement at time t+40 ms. The same measurement can be sent in the different reporting instances. However, the network is not aware if the received measurement is an old measurement or a new measurement that is taken between the two consecutive reports. As a result, L2 filtering at the network is not adapted properly and the filter time characteristics are not preserved.

The forgetting factor used for L2 filtering at the network can be adapted based on the timing information such that filter characteristics are be preserved at a different filtering input rate. The L2 filter forgetting factor can be expressed as

$$α = {2}^{\frac{- {k}_{L 3}}{4}} .$$

For L2 filtering, the network is not aware of the exact timing of the measurement performed by the UE. This does not matter for L3 filtering performed at the UE for L3 mobility as there is no delay between the L1 filtered value and L3 filtered value. However, there can be an issue with L1/L2 mobility where HO is performed based on L1 measurements.

Let's assume larger L1 beam reporting period, e.g., 80 ms is configured such that UE can have measurement from all panels within measurement reporting periodicity and the network receives Report 1 at time t and Report_2 at time t+80 ms. When the network receives the measurement report at time t+80 ms, the strongest measurement of the target beam will already be 55 ms old (SSB2 will be included in Report 2 as it is the strongest target gNB measurement). The network cannot adapt L2 filtering properly as it is not aware when this measurement was performed between two consecutive beam reporting instances. It is noted that the network is not necessarily aware of the panel scheduling at the UE and therefore, for example, the UE might activate the right panel at time t+40, and the measurement age can be in that case, e.g., 35 ms.

The interruption during the L1 handover execution can be reduced and the UE does not need to perform higher layer (RRC, PDCP) reconfiguration. The following describes certain examples for facilitating this by keeping/preserving filter time characteristics of a L2 filter at a network and improving measurement accuracy of L2 filtering. L2 filtering can be adapted to L1 measurements by a network entity and/or by a mobile device performing the measurements. In both cases the lower layer mobility processing is based on Layer 2 filtering of Layer 1 measurements by a communication device (UE) by taking advantage of processing of information of timing of Layer 1 measurements to adapt the Layer 1 measurements with Layer 2 filtering.

In accordance with an example a forgetting factor in the used L2 filtering equation is updated to reduce the impact of the age of the measurements. For Example, forgetting factor α in a L2 filtering equation Fₙ=(1−α)*Fₙ₋₁+α*Mⁿ is updated by considering L1 measurement timing information such that the impact of the “aged”/old measurements on the final L2 filtered Fₙ value is reduced.

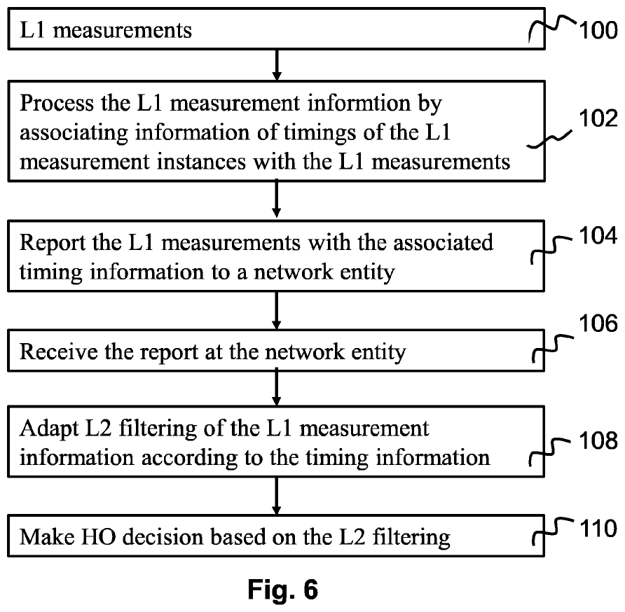

Flowchart of FIG. 6 shows an example of the general principles of a network based adaptation. At 100 a communication device performs Layer 1 measurements. At 102 information of the Layer 1 measurements is then processed by associating information of the timing of measurement instances with the measurement results. The processing can comprise including an indication of a measurement age of a measurement sample in the measurement report. The information of the timing of Layer 1 measurements included in the report can comprise information of a time difference between the timing of the reporting of a measurement sample and the timing of obtaining the measurement sample. The information of the timing of Layer 1 measurements may also comprises a flag indicative a difference between Layer 1 measurement samples. The report is sent at 104 to the source entity for use in L1/L2 based handover decision.

The communication device, a source entity and/or a target entity may be configured by a central node to handle the reporting of the information of the timing of Layer 1 measurements.

The source entity at the network receives the report at 106. The L2 filtering of the L1 measurement information can be adapted at 108 accordingly. A HO decision is made at 110 based on the L1/L2 adapted processing of the measurement information where the timing information has been taken into account.

In accordance with a more detailed example of the network based L1/L2 adaptation a communication device can be configured by a network entity such as a gNB to include measurement age information or flag indication as a part of Channel State Information (CSI) measurement reporting. This can be selectively configured for UEs using L1/2 mobility. Based on the received measurement age/flag indication the network can adapt the forgetting factor of the L2 filtering such that time characteristics of the filter can be preserved. L2 filtered L1 beam measurements is used to decide to send the MAC control element (CE) command to trigger handover/serving cell change.

New information element (IE) can be provided in messages to report and configure the operation. A UE can be configured by an gNB to include information about the timing of the measurement, e.g., measurement age information and/or flag indication as a part of the CSI measurement reporting.

The UEs can be selectively configured to use L1/2 mobility. A decision whether to use L1/2 mobility can be made in the network for example by a gNB or a CU based on a predefined rule.

UE capability indication for relevant features can be provided. For example, a DU can provide a measurement configuration including age/flag indication. The DU may require information about the UE capabilities, e.g., if it is multi-panel, when deciding the CSI measurement reporting configuration for the UE. This may be of assistance because the aging information is originated from the UE. In case the DU does not have the UE capability information, it can fetch this from the CU. The CU in turn has received this from the UE during RRC setup. The capability information may also be taken into account when deciding whether to use the L1/2 mobility.

Network can decide the configuration the UE shall use to report the age information. For example, whether exact timing or a flag shall be reported, which granularity of the timing in the report shall be used, the form of the reporting information element (IE) and so on. When UE receives a new IE for age information it can provide pre-processed, i.e., L2 adapted L1 measurement reports.

The age or timing information can be indicated in the measurements report in various manners. In accordance with a possibility one bit flag indication is send to the network. For example, if the L1 sample of the reported measurement is obtained between two consecutive CSI measurement reporting, the flag can be set to 1 to indicate that the measurement is “new”.

An option is to send timing value information. A time difference between two events or time relative to a point of time known to the network entity can also be reported. Measurement age can be indicated as the Δt denoting the time elapsed since the L1 sample of the measurement quantity is obtained. For example, a UE obtains the strongest non-serving cell beam measurement at a time, e.g., t+25 ms and the report is sent at another time t+80 ms. This information, Δt=55 ms, is included as a part of measurement report. This would provide elaborate information on measurement age to the network and the network can thus adapt the L2 filter more precisely.

Depending on the processing interval or periodicity at DU to take the received samples to the next level of filtering, DU/CU may configure threshold or maximum age to a UE. If the L1 sample is delayed beyond this time value one bit flag can indicate the same. DU can process this report immediately.

Based on the received measurement age/flag indication, the network can adapt the forgetting factor of the L2 filtering such that time characteristics of the filter can be preserved. A function can be configured that considers the age/flag information received from the UE in CSI measurement reporting, e.g., L1 beam reporting. An example for the function will be given later. L2 filtered L1 beam measurements can be used to decide to send the MAC CE command to trigger handover/serving cell change.

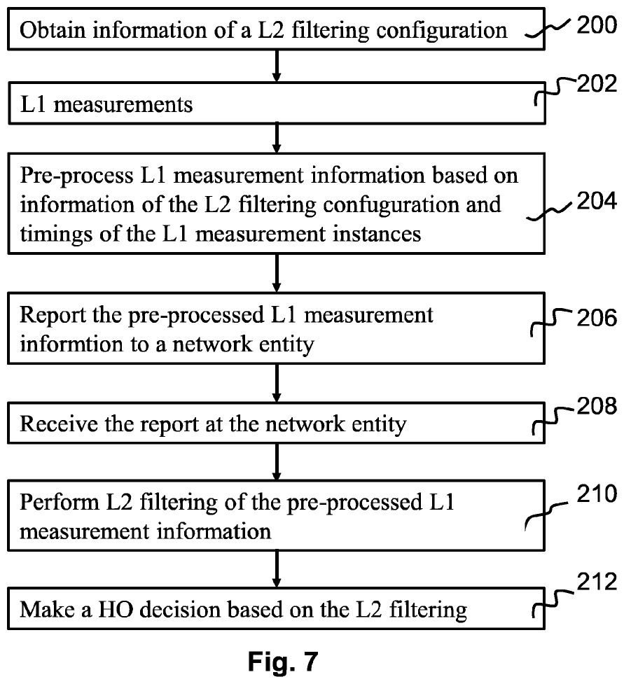

Flowchart of FIG. 7 shows an example of the general principles of adaptation at the mobile communication device where the processing comprises pre-processing at 204 Layer 1 measurements made at 202 by the communication device in accordance with Layer 2 filter configuration obtained at 200. The pre-processed L1 measurement information is then reported to an appropriate entity at the network at 206.

The network entity can receive the report including the pre-processed L1 measurement information at 208 and perform L2 filtering of the pre-processed L1 measurement information at 210. A handover decision can then be made accordingly at 212.

A network entity can provide at least a part of Layer 2 filter configuration information at 200 for use in the pre-processing at 204. At least a part of the Layer 2 filter configuration information may be provided via a target entity and/or a central entity controlling the source entity and the target entity. The communication device can thus receive the Layer 2 filter configuration information for the pre-processing at 200 from an appropriate source at the network, for example from a CU, a target DU or a source DU.

A central unit controlling a handover source and a handover target can determine the pre-processing method to be used and provide at 200 information of the determined pre-processing method on a higher layer signalling to the communication device. A possibility is that the source determines the pre-processing method to be used and provides information of the determined pre-processing method to the target and/or the communication device.

The communication device may compute at 202 a filtering coefficient to be used in the Layer 2 filtering. The communication may also perform other pre-processing, for example determine a new measurement reporting interval.

A UE can pre-process CSI measurements with L2 filter criteria that is provided by the network. A gNB can then process the pre-processed L1 measurements with L2 filtering. The L2 filtering may be of proprietary type, and the gNB may not need to be made aware of the timing information. A gNB can be configured to perform configuration of the UE for the pre-processing.

In the UE based adaptation L2 filter at the network does not need to be standardized. The adaptation, or at least part thereof, can be provided at the UE. The following aspects cover the impact on the UE side considering a couple of possible scenarios.

On first scenario the L2 filter at the network is standardized. L2 filter configuration should be transparent to UE so that UE adapts the reported L1 measurements to preserve the L2 filter characteristics and reports pre-processed L1 measurements. The pre-processing at the UE can consider the measurement age information to adapt the L1 measurements to preserve the filter characteristics. Standardization of the L2 filter can be assumed and the network can provide the UE with information related to the L2 filter configuration. The UE can then adapt the information for input to the L2 filter to maintain L2 filter time characteristics. The effect of this is similar to adaptation of the filter characteristics on sampling rate at the network, the difference being that the input of the filter (L1 measurements) is adapted by pre-processing on UE side before reporting instead of adapting the filter on the network side.

In another scenario the L2 filter is network implementation specific. The network can determine the method on adapting the reported L1 measurements. UE pre-processes/adapts the L1 measurements using the method determined by the network. A deterministic function can be defined by the network, using the L1 measurements, measurement delays and reporting delays as input to produce new L1 measurements that are adapted to the L2 filter input. UE can report the pre-processed L1 measurements marked as L1 measurement reporting. Another possibility is that the UE calculates a new filtering coefficient based on L1 input rate and sends this as a part of the L1 measurement reporting. The network then uses the new filtering coefficient for L2 filtering.

Optimising of the report configuration for filtering of L1 report at the network may also be based on initial measurements over multiple panels. This can be provided in response the UE determining that better reporting interval configuration is preferred to improve accuracy of the filtering at the network. This can be provided to report the measurements based on all panel measurements and panel switching periodicity. The UE may propose a reporting configuration change via RRC or MAC signaling as assistance information. This may be needed, e.g., if panel switching periodicity is a UE specific implementation and not known to the network.

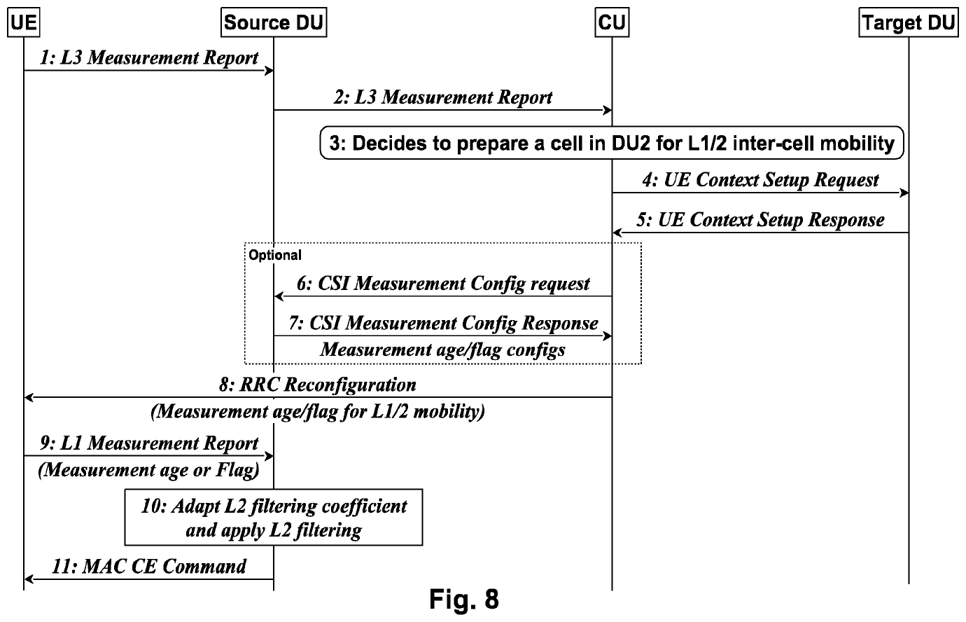

More detailed examples will now be explained with reference to FIGS. 8 to 12. Signalling exchange in accordance with an example shown in FIG. 8 assumes that the HO steps are essentially similar to those for preparing target cells in FIG. 5, and therefore these steps are not explained again. The source DU cells can have been prepared for the UE with or without measurement age reporting.

In the beginning of FIG. 8, step 1, the UE is configured for L1/2 mobility with the cells of the source DU (DU1). The configuration includes making the UE aware of the measurement age. In step 2 the UE provides L3 measurement report to the CU. In step 3 the CU decides to prepare a cell in the target DU (DU2) for L1/2 inter-cell mobility.

In optional step 4 the CU can send to the source DU UE context modification request with “measurement age query IE” to fetch the configuration of measurement age/flag information. This can be useful to fetch any DU-specific information. In optional step 5 the source DU sends the response including the information about the measurement age/flag configurations. In this message, source DU can indicate whether to use measurement age with Δt or flag indication for L2 filter adaptation. Source DU may also describe the granularity level of the measurement age. For example, using two-bit indications:
Δt=5 ms→00
Δt=15 ms→01
Δt=25 ms→10
Δt=25 ms→11

The condition to generate the flag or measurement age mapping also can be network control parameter in-terms of delay of report at UE.

Steps 4 and 5 are not necessary in all scenarios, and can be skipped, e.g., if the CU already has the measurement configuration of the source DU.

In step 6 the CU-CP sends the measurement age/flag configurations received from the source DU to the target DU. This can be performed in case the target DU generates the CSI Measurement configuration for L1/2 inter-cell mobility.

In step 7 the target DU sends to the CU a DU-To-CU Container (CellGroupConfig) including the measurement age/flag configurations in the CSI-MeasConfig.

In step 8 the CU sends the received CSI-MeasConfig in the CellGroupConfig to the UE as a part of RRC reconfiguration. Measurement age/flag configurations can be encoded in the CellGroupConfig (prepared by the DU). Another possibility is that the CU includes the measurement age/flag configuration without involving the target DU.

In step 9 the UE confirms the RRC Reconfiguration to the network/the CU.

In step 10 the UE includes the measurement age or flag indication for each measurement sample in the CSI measurement reporting instance. If the measurement sample is updated within two measurement instances, the flag is set to 1, otherwise it is set to 0 (or vice versa depending on the configuration). The UE can report Δt as the time difference between the time instant t₁ of CSI measurement reporting and the time instant t₂ at which the L1 sample of the measurement quantity has been obtained.

In step 11 the source DU receives the CSI measurement report with measurement age/flag indication and adapts the L2 filter based on this information. Filtering coefficient can then be is adapted according to the age information in the measurement report.

Forgetting factor α in equation Fₙ=(1−α)*Fₙ₋₁+α*Mₙ can be reduced such that the impact of the aged measurements (based on Δt or indication flag) on final L2 filtered Fₙ value is reduced. It can be defined for example that

$$α = {2}^{\frac{f ( - {k}_{L 3} , age / flag )}{4}} ,$$

where f(−k_{L3}, age/flag) function considers the age/flag information received from the UE in CSI measurement reporting, e.g., L1 beam reporting.

It can also be assumed that the same SSB indexSSBₜⁱ has been reported in consecutive CSI measurement reports over time with one bit flag information. For each reported quantity, the network can compute a considering measurement flag information.
(SSBₜⁱ, flag=1)→αₜⁱ
(SSBₜ₊₁ⁱ, flag=0)→αₜ₊₁ⁱ
(SSBₜ₊₂ⁱ, flag=0)→αₜ₊₂ⁱ
(SSBₜ₊₃ⁱ, flag=0)→αₜ₊₃ⁱ

In this example, forgetting factor for the measurement quantity SSBₜⁱ reduces over time such that αₜⁱ>αₜ₊₁ⁱ>αₜ₊₂ⁱ>αₜ₊₃ⁱ.

The results of the L2 filtered L1 sample is used to determine whether to trigger a beam/cell change. In step 12, if the L2 filtered non-serving cell beam measurement is higher than the serving cell beam by offset, the source DU sends MAC CE command to trigger a handover procedure.

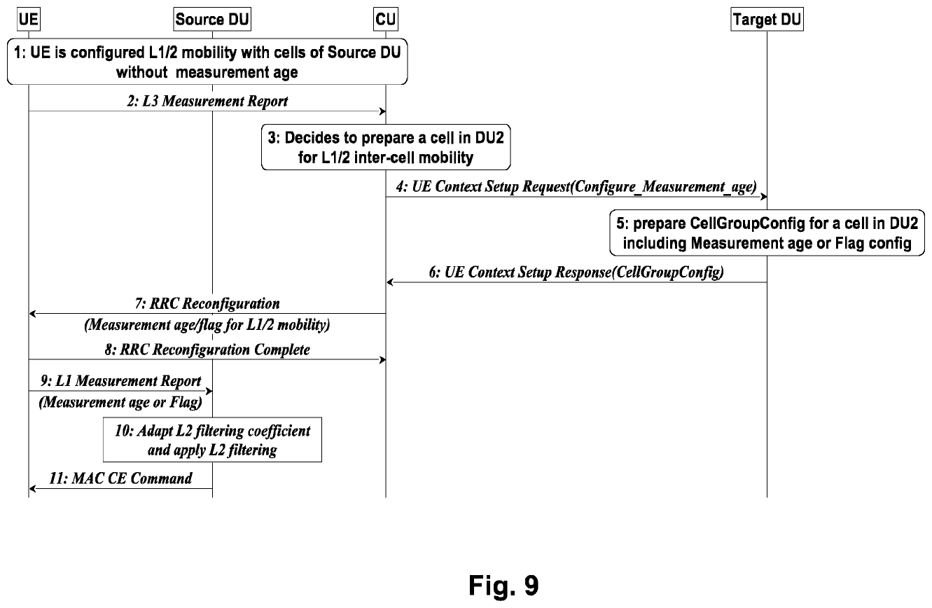

In accordance with another scenario shown in FIG. 9 the measurement age configuration may not be available at the source DU. For example, none of the source DU cells were prepared with measurement age/flag configurations at step 1. In step 2 the UE provides L3 measurement report to the CU. In step 3 the CU decides to prepare a cell in the target DU for L1/2 inter-cell mobility. The CU can ask the target DU to configure the measurement age configuration, by including a flag in the UE Context Setup Request message sent at step 4. The UE can deliver its capability in RRC setup and CU will forward this to DU in UE context setup. The multi-panel capabilities are also included. The rest of the steps can be as in FIG. 8.

The above concept of adapting filtering based on measurement flag has been tested by simulations performed in order to analyse the impact of reporting measurement age/flag as a part of CSI measurement reporting. In the simulations the timing flag was set to 1 if the measurement is updated within consecutive reporting instances, otherwise this was set to 0. The forgetting factor was scaled such that the impact of the aged measurements was reduced. A comparison of the adaptive L2 filtering method was compared with fixed L2 filtering. The fixed L2 filtering does not consider the impact of the measurement for the L2 filter, whereas the adaptive L2 filtering disclosed herein considers the impact of the measurement age for adapting the L2 filtering.

The SSB periodicity was assumed to be 20 ms, i.e., every SSB period (20 ms) with a single beam and CSI measurement reporting periodicity of 20 ms. In addition, fast fading process in dB (Rayleigh, Jakes spectrum, worst case)), no slow fading was applied. L1 filter was a sliding window of three samples. IIR L2 filter was applied at the network with filtering time constant of 200 ms. Simulation duration was 200 sec. 10000 samples were used.

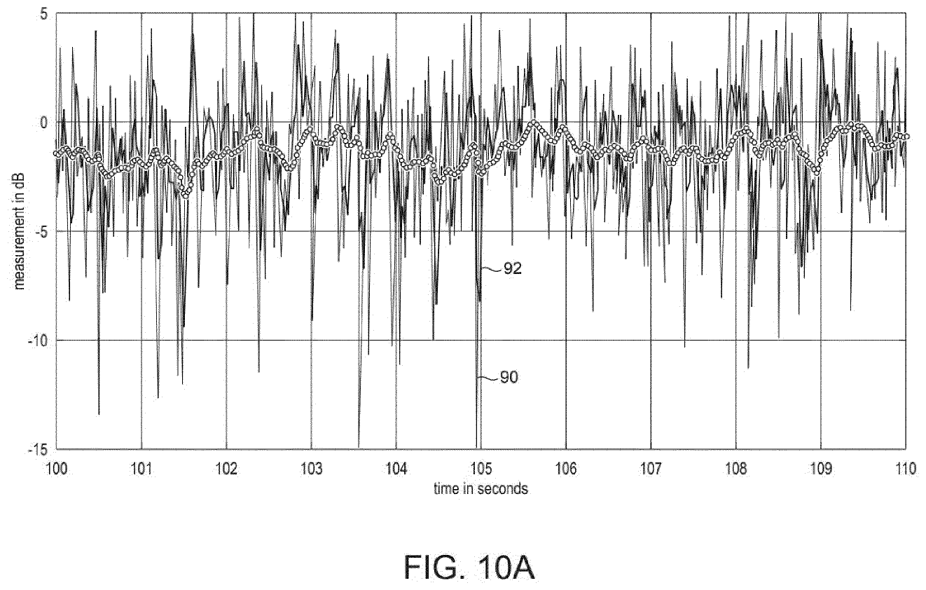

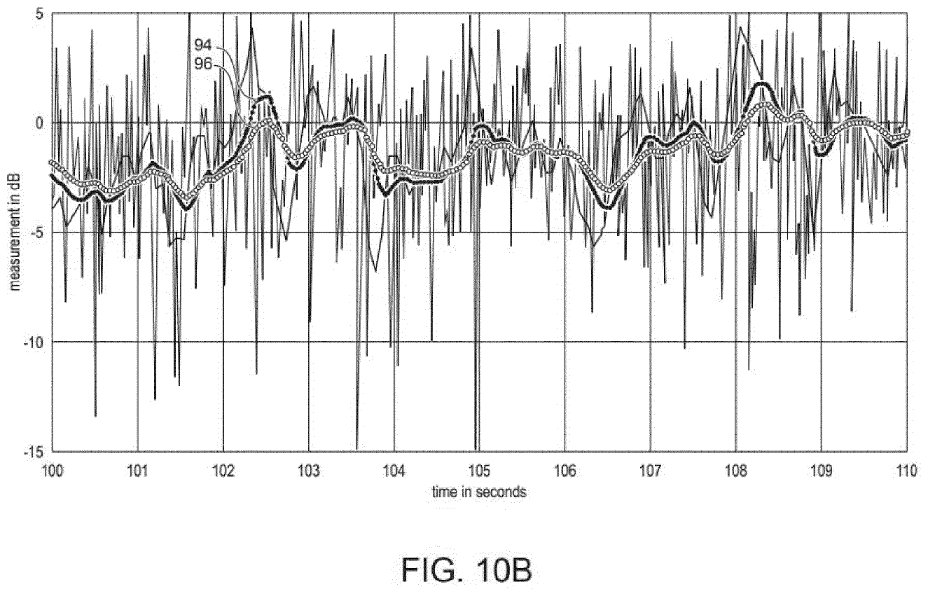

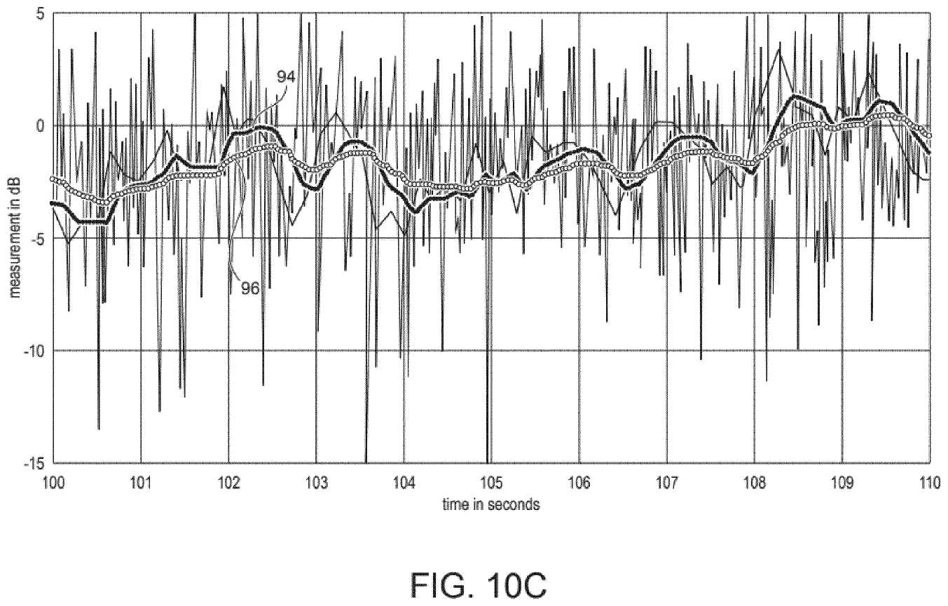

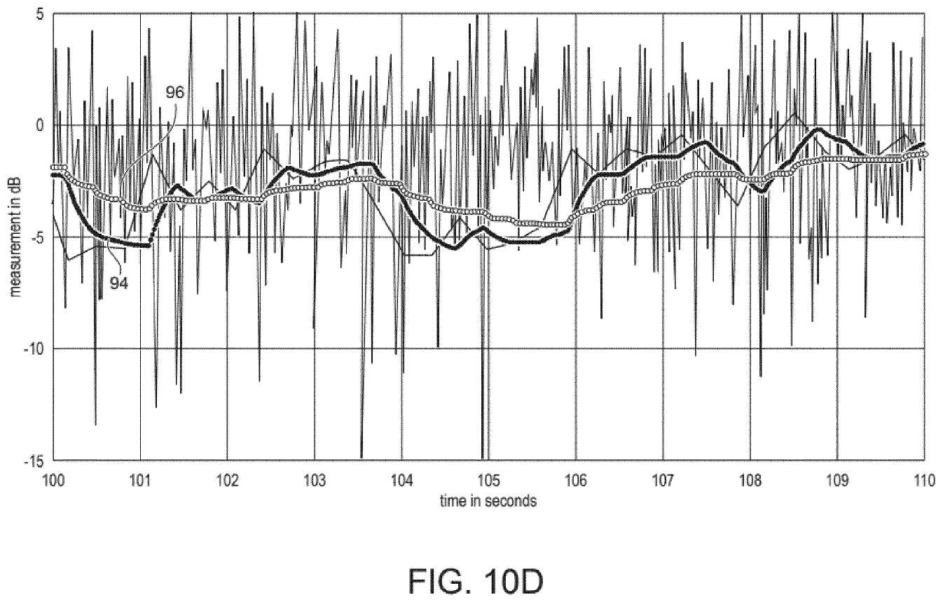

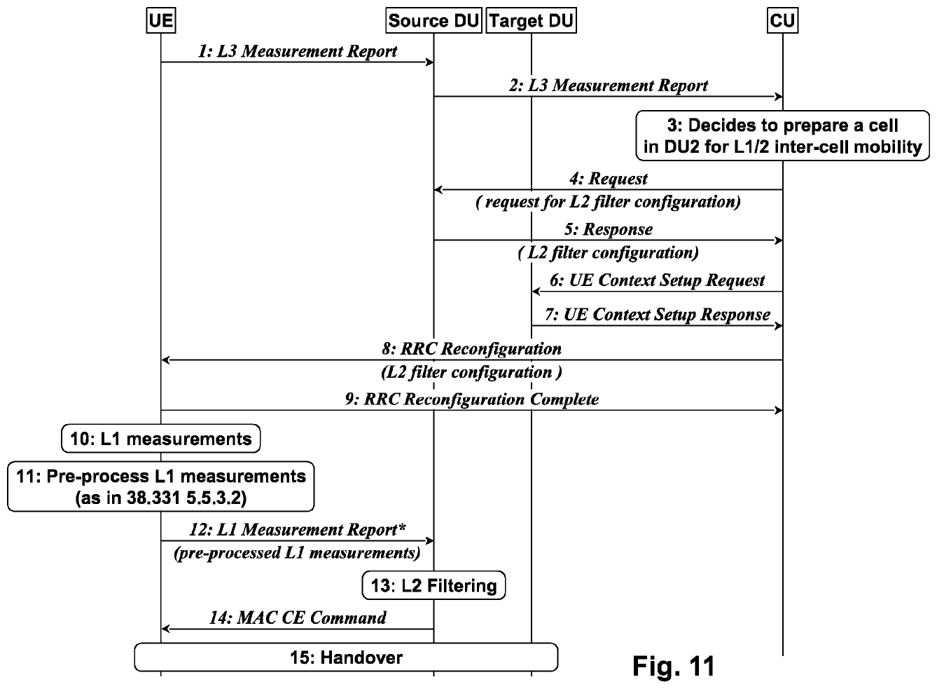

Some of the results are shown in the plots of FIGS. 10A, 10B, 10C and 10D where each plot shows a period of 10 secs. The plots differ in the max measurement age that can be considered for MPUE as number of panels X Panel scheduling ratio. In FIG. 10A the max measurement age=1, in FIG. 10B the max measurement age=4, in FIG. 10C the max measurement age=8, and in FIG. 10D the max measurement age=16. The measurement age in this presentation is defined as the normalized value, based on CSI periodicity, of the time difference between two updated measurements. For example, when the measurement is 4, there is 80 ms between two updated measurements as 20 ms is the CSI reporting periodicity (i.e., the measurement age is 80/20=4). Measurement age 1 means that for each reported measurement, the measurement is updated (20/20=1).

Four plot lines are presented such that plot 90 showing the widest fluctuation denotes raw SSB sample values, plot 92 denotes L1 filtered measurements (considering also down sampling), plot 94 denotes L2 filtered values with fixed L2 filtering, and plot 96 denotes L2 adaptive filtering based on measurement age flag.

Max measurement age=1 in FIG. 10A means that a four panel MPUE activates all panels at a time (e.g., every 20 ms) to perform SSB measurements. Therefore, CSI Measurement age flag will be set to one for each CSI reporting.

Max measurement age=4 in FIG. 10B means that, e.g., for MPUE with four panels, only one panel is activated at a time to perform SSB measurement and (Max measurement age)×20 ms (SSB periodicity)=80 ms is required to update the measurement on the strongest panel for non-serving cell beam. Therefore, with max measurement age 4, UE reports:
Time t, measurement is updated Flag: 1
Time t+20 ms, measurement is not updated—Flag: 0
Time t+40 ms, measurement is not updated—Flag: 0
Time t+60 ms, measurement is not updated—Flag: 0
Time t+80 ms, measurement is updated—Flag: 1

It can be observed that standard deviation of the processes indicates measurement accuracy. Substantially similar accuracy is acquired for L1 filtered measurements under max measurement age 1 (FIG. 10A) and max measurement age 4 (FIG. 10B). This is so because the same L1 filter is applied on the two measurements where both has the same statistical properties. Measurement accuracy (in terms of STD) decreases drastically for fixed L2 filter with increase of the max measurement age (red curve in right FIG. 10B). Measurement accuracy is improved with adaptive L2 filtering for max measurement age 4 (blue curve in right figure). In Numbers:
Fixed L2 filtering STD: 1.125 dB
Adaptive L2 filtering STD: 0.861 dB

FIGS. 10C and 10D show the results with higher measurement age values (8 and 16, respectively). These are even clearer in that with the adaptive L2 filtering measurement accuracy of the L2 filtering at the network can be improved.

In the above IIR filter is used as L2 filter as an example at the network based on the measurement age/flag information. The similar issues can be resolved based on UE adaptation on L1 filtered samples. Examples of such scenarios will be discussed next.

FIG. 11 illustrates a scenario where the L2 filter at the network is standardised, for example by the 3GPP. The signalling diagram shows that at step 4 the CU requests the source DU to provide its L2 filter configuration which the DU then provides in response in step 5. The CU forwards the L2 filter configuration to the UE in step 8.

In accordance with a possibility the L2 filtering configuration is forwarded to the target DU in step 6. The target DU in turn includes it in a CSI measurement configuration that can be provided to the UE via the CU steps 7 and 8.

In steps 10 the UE performs the L1 measurements. In step 11 the UE pre-processes the L1 measurements. At step 12, the UE can send the pre-processed L1 measurements in the CSI measurement report. At step 13, the network does not need to adapt the L1 measurements or the L2 filtering based on age information as the UE already has done that and provides pre-processed L1 measurements based on the measurement timing. So, the network can apply fixed L2 filtering to decide to trigger MAC CE command for handover.

In this scenario, the L2 filter configuration at the network is known to the UE and the UE weights the L1 measurements based on the age information (e.g., At) and reports the L1 pre-processed measurement information to the network without age information.

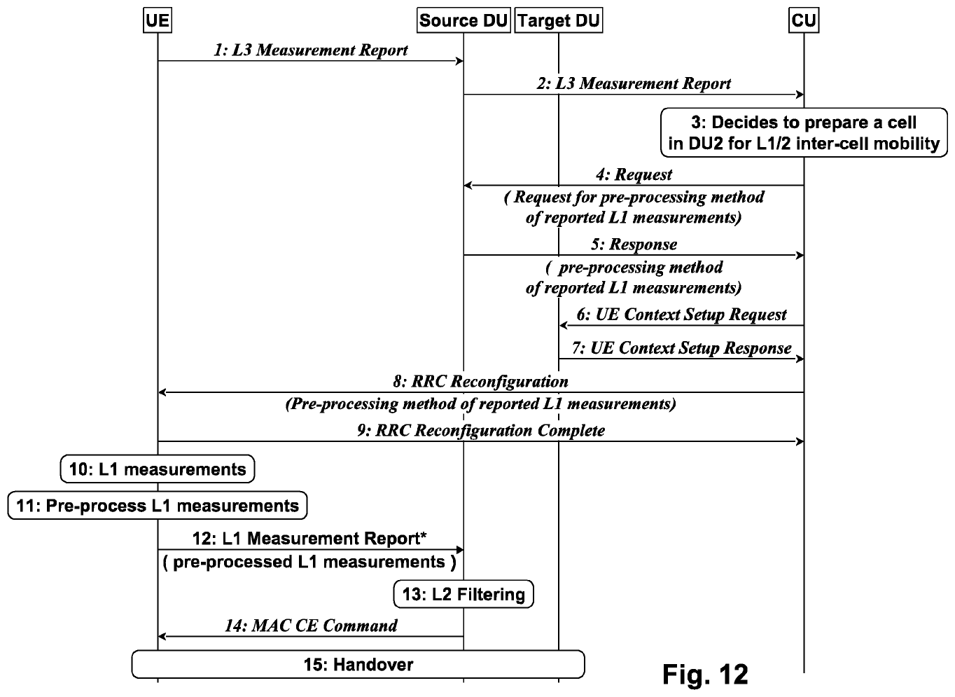

In another scenario the L2 filter is not standardized but can be network implementation specific. FIG. 12 shows a signaling diagram for operation where L2 filter is network implementation specific. The network can determine the method on adapting the reported L1 measurements. The method can be a deterministic function that uses the L1 measurements, measurement delays and reporting delays as input to produce adapted L1 measurements for the L2 filter input. At step 8, the CU sends the method to be used at the network as a part of the RRC reconfiguration.

Another possibility is that the pre-processing method of reported L1 measurement (selected by serving DU) is forwarded to target DU in step 6 which in turns includes it in a CSI measurement configuration that is provided to the UE via the CU in steps 7-8.

In another embodiment, UE reports new filtering coefficients based on L1 input rate and send as a part of L1 measurement report or any lower layer (e.g. MAC CE) or higher layer (e.g., RRC) message. The network will use the new filtering coefficients for L2 filtering.

The network can thus be provided with measurement age information of the L1 beam measurements so as to enable L2 filtering by preserving the time characteristics of the L2 filter. With an adaptive L2 filtering, the number of ping-pongs in L1/2 centric inter-cell mobility may be reduced. This can also assist in avoiding high signaling overhead and interruption time. Good measurement accuracy of layer 2 filtering may be provided. Reliable mobility decisions irrespective of MPUE panel activation algorithm may be provided.

In accordance with an aspect a communication device comprises means for performing Layer 1 measurements and means for processing information of the measurements by the communication device, the processing including use of information of timing of the Layer 1 measurements to adapt the Layer 1 measurements with Layer 2 filtering. The means for processing can include information of the timing of the Layer 1 measurements in a measurement report by the communication device.

The means for processing may also pre-process the Layer 1 measurements in accordance with Layer 2 filter configuration and report the pre-processed measurement information for use in the Layer 2 filtering.

The communication device may comprise a multi-panel wireless means and be capable of performing measurements in at least two directions.

At least one of a handover source entity and/or a handover target entity can comprise means for handling reporting of information of timing of Layer 1 measurements.

Means for signaling Layer 2 filter configuration information for use in pre-processing of measurement information by the communication device may be provided.

It is noted that while the above describes example embodiments, there are several variations and modifications which may be made to the disclosed solution without departing from the scope of the present invention. Different features from different embodiments may be combined.

The embodiments may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software stored in a memory and executable by at least one data processor of the involved entities or by hardware, or by a combination of software and hardware. Further in this regard it should be noted that any of the above procedures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non-limiting examples. Alternatively or additionally some embodiments may be implemented using circuitry. The circuitry may be configured to perform one or more of the functions and/or method procedures previously described. That circuitry may be provided in the network entity and/or in the communications device and/or a server and/or a device.

As used in this application, the term “circuitry” may refer to one or more or all of the following:
(a) hardware-only circuit implementations (such as implementations in only analogue and/or digital circuitry);
(b) combinations of hardware circuits and software, such as: (i) a combination of analogue and/or digital hardware circuit(s) with software/firmware and (ii) any portions of hardware processor(s) with software (including digital signal processor(s)), software, and memory(ies) that work together to cause the communications device and/or device and/or server and/or network entity to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

It is noted that whilst embodiments have been described in relation to certain architectures, similar principles can be applied to other systems. Therefore, although certain embodiments were described above by way of example with reference to certain exemplifying architectures for wireless networks, technologies standards, and protocols, the herein described features may be applied to any other suitable forms of systems, architectures and devices than those illustrated and described in detail in the above examples. It is also noted that different combinations of different embodiments are possible. It is also noted herein that while the above describes exemplifying embodiments, there are several variations and modifications which may be made to the disclosed solution without departing from the spirit and scope of the present invention.

1. A method for processing information of Layer 1 measurements taken by a communication device, the method comprising using information of timing of the Layer 1 measurements to adapt the Layer 1 measurements with Layer 2 filtering.

2. The method of claim 1, comprising including information of the timing of Layer 1 measurements in a measurement report by the communication device.

3. The method of claim 2, comprising including an indication of measurement age of a measurement sample in the measurement report.

4. The method of claim 1, comprising configuring at least one of the communication device, a handover source entity and/or a handover target entity to handle reporting of the information of the timing of Layer 1 measurements.

5. The method of claim 1, wherein the information of the timing of Layer 1 measurements comprises information of a time difference between the timing of reporting of a measurement sample and the timing of obtaining the measurement sample.

6. The method of claim 1, wherein the information of the timing of Layer 1 measurements comprises a flag indicative whether a measurement of a corresponding reference signal is taken after a previous measurement report.

7. The method of claim 1, comprising pre-processing of the Layer 1 measurements by the communication device in accordance with Layer 2 filter configuration and reporting the pre-processed measurement information for use in the Layer 2 filtering.

8. The method of claim 7, comprising the communication device receiving Layer 2 filter configuration information for the pre-processing.

9. The method of claim 7, wherein a handover source entity provides at least a part of Layer 2 filter configuration information for use in the pre-processing.

10. The method of claim 7, wherein at least a part of Layer 2 filter configuration information is provided via a handover target entity.

11. The method of claim 7, wherein a central node controlling at least one of a handover source entity and a handover target entity determines the pre-processing method to be used and provides information of the determined pre-processing method on a higher layer signaling to the communication device, or wherein a handover source entity determines the pre-processing method to be used and provides information of the determined pre-processing method.

12. The method of claim 7, comprising the communication device computing a filtering coefficient to be used in the Layer 2 filtering and/or determining a new measurement reporting interval.

13. The method of claim 1, comprising adapting a Layer 2 filter based on the information of timing of Layer 1 measurements, and/or adapting the input into the Layer 2 filter based on the characteristics of the Layer 2 filter.

14. The method of claim 13, wherein the adapting comprises at least one of adjusting a filtering coefficient, adjusting a forgetting factor, weighting the Layer 1 measurements, adjusting timing of processing the measurement results, comparing the timing information to a timing threshold, adaptation of Layer 2 filter time characteristics and/or applying the sampling rate to Layer 2 Infinite Impulse Response filtering such that the time characteristics of the Layer 2 filter are preserved.

15. The method of claim 1, wherein the communication device comprises a multi-panel device configured to perform measurements in at least two directions.

16. An apparatus comprising at least one processor and at least one memory including a computer program code, the at least one memory and computer program code configured to, with the at least one processor, cause the apparatus at least to process information of Layer 1 measurements taken by a communication device, the processing comprising use of information of timing of the Layer 1 measurements to adapt the Layer 1 measurements with Layer 2 filtering.

17. The apparatus of claim 16, configured to include into or obtain from a measurement report an indication of measurement age of a measurement sample.

18. The apparatus of claim 16, configured to handle a report of the information of the timing of Layer 1 measurements in at least one of the communication device, a handover source entity and/or a handover target entity.

19. The apparatus of claim 16, wherein the information of the timing of Layer 1 measurements comprises information of a time difference between the timing of reporting of a measurement sample and the timing of obtaining the measurement sample, and/or wherein the information of the timing of Layer 1 measurements comprises a flag indicative whether a measurement of a corresponding reference signal is taken after a previous measurement report.

20. The apparatus of claim 16, comprising the communication device configured to perform the Layer 1 measurements and include information of the timing of the performed Layer 1 measurements in a measurement report for sending to a network entity.

21. The apparatus of claim 16, comprising the communication device configured to pre-process the Layer 1 measurements in accordance with Layer 2 filter configuration and report the pre-processed measurement information for use in the Layer 2 filtering.

22. The apparatus of claim 21, wherein the communication device is configured to receive and apply Layer 2 filter configuration information for the pre-processing.

23. The apparatus of claim 21, wherein a handover source entity and/or a handover target entity is configured to provide at least a part of Layer 2 filter configuration information for use in the pre-processing.

24. The apparatus of claim 21, wherein a pre-processing method to be used is determined by a central node controlling at least one of a handover source entity and a handover target entity, and information of the determined pre-processing method is provided on a higher layer signaling to the communication device, or wherein a pre-processing method to be used is determined and provided by a handover source entity determines the pre-processing method to be used.

25. The apparatus of claim 21, comprising the communication device configured to compute a filtering coefficient to be used in the Layer 2 filtering and/or determine a new measurement reporting interval.

26. The apparatus of claim 16, configured to adapt a Layer 2 filter based on the information of timing of Layer 1 measurements, and/or adapt the input into the Layer 2 filter based on the characteristics of the Layer 2 filter.

27. The apparatus of claim 26, configured to adapt at least one of a filtering coefficient, a forgetting factor, weighting of Layer 1 measurements, timing of processing of measurement results, and/or Layer 2 filter time characteristics.

28. The apparatus of claim 26, configured to compare the timing information to a timing threshold, and/or apply the sampling rate to Layer 2 Infinite Impulse Response filtering such that the time characteristics of the Layer 2 filter are preserved.

29. The apparatus of claim 16, wherein the communication device comprises a multi-panel device configured to perform measurements in at least two directions.

30. A computer readable media comprising program code for causing a processor to perform instructions for a method as claimed in claim 1.
